(19) United States
(12) Patent Application Publication
(10) Pub. No.: US 2004/0116315 A1
(43) Pub. Date: Jun. 17, 2004

(54) Liquid composition for cleaning hydrophobic substrate and cleaning method therewith

(75) Inventors: Hidemitsu Aoki, Kanagawa (JP); Hiroaki Tomimori, Kanagawa (JP); Yoshiko Kasama, Kanagawa (JP); Haruki Nojo, Kanagawa (JP)

Correspondence Address: YOUNG & THOMPSON, 745 SOUTH 23RD STREET 2ND FLOOR, ARLINGTON, VA, 22202

(73) Assignees: NEC ELECTRONICS CORPORATION, KANAGAWA (JP); EKC TECHNOLOGY K.K., KANAGAWA (JP)

(21) Appl. No.: 10/717,715

(22) Filed: Nov. 21, 2003

(30) Foreign Application Priority Data
Nov. 29, 2002 (JP) 2002-348204

(51) Int. Cl. C11D 17/00

(52) U.S. Cl. 510/421

(57) ABSTRACT

This invention provides a liquid composition for cleaning a hydrophobic substrate which is used for cleaning a substrate having a surface area on which a water droplet exhibits a contact angle of 60° or more, comprising a phosphonic acid chelating agent having at least two phosphonic groups in one molecule and a polyoxyalkylene alkyl ether type of nonionic surfactant, wherein a droplet of the liquid composition or a dilute aqueous solution thereof exhibits a contact angle of 50° or less to the surface area.

### BACKGROUND OF THE INVENTION

1. Field of the Invention

This invention relates to a liquid composition for cleaning a hydrophobic substrate and a cleaning method with the composition. In particular, it relates to a cleaning liquid and a cleaning method suitable for cleaning a substrate after chemical mechanical polishing (hereinafter, referred to as “CMP”) in a process for manufacturing a semiconductor device.

2. Description of the Related Art

As ICs (Integrated Circuits) have been increasingly integrated, trace amounts of contaminants remaining on a semiconductor substrate during the manufacturing process therefor have had more significant effects on device performance and a yield. Thus, much stricter contamination control has been needed. Therefore, cleaning with a variety of liquid cleaners has been conducted in individual steps in a process for manufacturing a semiconductor device.

For example, in the steps for manufacturing a multilayered semiconductor device, CMP technique has been introduced for leveling an insulating film or forming a damascene interconnection, and adequately effective removal of contaminants is needed in cleaning after such a CMP process.

CMP is conducted by pressing a wafer on a pad placed in a platen and rotating the wafer and the platen while feeding a slurry containing polishing particles and a chemical agent. During the process, the wafer surface is leveled by mechanical action of the polishing particles in the slurry and chemical action of the chemical agent. After such CMP, the wafer surface is contaminated with a large amount of particles or metallic contaminants. The particles are derived from the polishing particles (inorganic particles such as silica or alumina) in the slurry, and the metallic contaminants are derived from an interconnection material such as copper which is polished during forming a damascene interconnection or a via metal. Before the next step, cleaning is, therefore, necessary, by which these contaminants can be adequately removed.

However, a conventional acidic cleaner containing an acid such as hydrochloric acid, sulfuric acid and hydrofluoric acid tends to erode a metal interconnection such as copper and also is not suitable for removing particles. On the other hand, an alkaline cleaner containing, for example, aqueous ammonium hydroxide is known to be highly effective in removing particles, but it may damage not only a metal interconnection such copper but also an insulating layer.

Thus, cleaning techniques have been proposed for removing contaminants such as particles and metallic contaminants while preventing damage on a metal interconnection or insulating layer exposed in a substrate surface.

For example, Japanese Laid-open Patent Publication No. 10-72594 has disclosed a cleaning agent comprising an organic acid having at least one carboxyl group and a complexing agent of phosphonic acid derivatives for removing particles or metallic contaminants without erosion of a metal interconnection on a semiconductor substrate or deterioration in flatness of the substrate surface.

Japanese Laid-open Patent Publication No. 11-116984 has disclosed a cleaning agent comprising a compound having at least two phosphonic group in a molecule and a particular nonionic surfactant for removing solid particles and oil contaminants adhering to a semiconductor substrate while preventing foaming.

Japanese Laid-open Patent Publication No. 11-131093 has disclosed a cleaning liquid comprising at least one of oxalic acid, ammonium oxalate and polyaminocarboxylic acids without containing hydrogen fluoride for removing metallic contaminants on the upper surface of a semiconductor substrate without erosion of a metal interconnection on the semiconductor surface and without environmental loading or a problem in preservability.

Japanese Laid-open Patent Publication No. 2001-7071 has disclosed a cleaning liquid comprising at least one of a dispersing agent of a condensed phosphoric acid or phosphate and an anionic or nonionic surfactant and an organic compound selected from the group consisting of oxalic acid, malonic acid, succinic acid, malic acid, tartaric acid, citric acid and their ammonium salts as well as the cleaning liquid further comprising a chelating agent of a polyaminocarboxylic acid for removing metallic contaminants and particles on the upper surface of a substrate without erosion of a metal interconnection on the semiconductor substrate.

Japanese Laid-open Patent Publication No. 2002-20787 has disclosed a cleaning agent comprising a particular nonionic surfactant as well as the cleaning agent further comprising a particular quaternary ammonium for removing particles and metallic contaminants without erosion or oxidation of a copper interconnection in the surface of a semiconductor substrate and without surface roughness. The publication has described that cleaning effect can be improved by making the cleaning agent alkaline of pH≧9 and that a chelating agent of phosphonic acid derivatives may be further added.

Increase in an interconnection capacity along with a recent increasingly integrated IC (Integrated Circuit) causes interconnection delay, which is a rate-limiting factor in fast response in a device. Thus, an interconnection delay has been reduced by using a low-resistivity material such as copper (Cu) as an interconnection material and further using a low dielectric-constant material in place of a conventional silicon dioxide as a material for an interlayer insulating film or an inter-interconnection insulating film.

Such a low dielectric-constant material is, however, less wettable, i. e., more hydrophobic, than the conventional silicon oxide. Therefore, a substrate surface in which a film made of a low dielectric-constant material is exposed cannot be adequately cleaned with a conventional cleaning agent.

For example, when cleaning an interlayer insulating film made of a low dielectric-constant material after leveling it by CMP, particles cannot be sufficiently removed by single-wafer-processing cleaning in which a cleaning liquid is sprinkled on a substrate surface.

Particles cannot be also sufficiently removed when cleaning is conducted after CMP in the process for forming a damascene interconnection using a low dielectric-constant material as an interlayer insulating film. Even when covering the layer made of the low dielectric-constant material between interconnections with a conventional silicon dioxide layer, the lower layer, i. e., the low dielectric-constant layer, tends to be exposed due to over-polishing, and in such an exposed area, particles cannot be sufficiently removed. Furthermore, since copper is also polished during the process for forming a damascene interconnection, contaminants derived from the polishing dusts must be removed by cleaning.

### SUMMARY OF THE INVENTION

An objective of this invention is to provide a liquid composition for cleaning a hydrophobic substrate and a cleaning method, whereby even particles adhering to a substrate surface where a hydrophobic surface is exposed can be adequately removed and at the same time metallic contaminants can be removed.

According to the first aspect of the invention, there is provided that a liquid composition for cleaning a hydrophobic substrate which is used for cleaning a substrate having a surface area on which a water droplet exhibits a contact angle of 60° or more, comprising

a phosphonic acid chelating agent having at least two phosphonic groups in one molecule and a polyoxyalkylene alkyl ether type of nonionic surfactant,

wherein a droplet of the liquid composition or a dilute aqueous solution thereof exhibits a contact angle of 50° or less to the surface area.

According to another aspect of the invention, there is provided that the liquid composition for cleaning a hydrophobic substrate of the first aspect of the invention wherein the surface area is a low dielectric-constant film having a dielectric-constant of 4 or less.

According to another aspect of the invention, there is provided that the liquid composition for cleaning a hydrophobic substrate of the first aspect of the invention wherein a droplet of an aqueous solution prepared by dissolving the nonionic surfactant in water exhibits a contact angle of 50° or less to the surface area.

According to another aspect of the invention, there is provided that the liquid composition for cleaning a hydrophobic substrate of the first aspect of the invention wherein the nonionic surfactant is represented by general formula (1):

R—O—(CH₂CH₂O)ₙH (1)

wherein R represents alkyl group having 8 to 22 carbon atoms and n represents an integer of 1 to 30.

According to another aspect of the invention, there is provided that the liquid composition for cleaning a hydrophobic substrate of the first aspect of the invention wherein the phosphonic acid chelating agent is one or two or more selected from the group consisting of 1-hydroxyethylidene-1,1-diphosphonic acid, ethylenediamine tetramethylenephosphonic acid, aminotrimethylenephosphonic acid and their salts.

According to another aspect of the invention, there is provided that the liquid composition for cleaning a hydrophobic substrate of the first aspect of the invention wherein pH is within the range of 2 to 6.

According to the second aspect of the invention, there is provided that a process for cleaning a substrate having a surface area where a water droplet exhibits a contact angle of 60° or more, comprising the steps of preparing the liquid composition of the first aspect of the invention and removing adherent materials on the substrate surface while feeding the liquid composition or a dilute aqueous solution thereof to the substrate surface.

According to another aspect of the invention, there is provided that the cleaning process of the second aspect of the invention wherein the substrate surface is scrubbed with a brush while feeding the liquid composition or a dilute aqueous solution thereof to the substrate surface.

According to another aspect of the invention, there is provided that the cleaning process of the second aspect of the invention wherein the adhesive materials to be removed are particles and metallic contaminants.

This invention can provide a liquid composition and a cleaning process, which can adequately remove even particles adhering to a substrate surface having a hydrophobic surface area and show cleaning performance to metallic contaminants.

### DETAILED DESCRIPTION OF THE INVENTION

Preferred embodiments of this invention will be described.

A liquid composition for cleaning a hydrophobic substrate according to this invention (hereinafter, referred to as “liquid composition”) comprises a phosphonic acid chelating agent having at least two phosphonic groups in one molecule (hereinafter, referred to as “phosphonic acid chelating agent”) and a polyoxyalkylene alkyl ether type of nonionic surfactant (hereinafter, referred to as “polyoxyalkylene alkyl ether surfactant”), and is suitable for cleaning contaminating particles and/or metals from a substrate having a hydrophobic surface area (hereinafter, referred to as “hydrophobic substrate”) such as a silicon substrate (a substrate without an oxide film on its surface in which a silicon surface is exposed) or low dielectric-constant film (Low-K film).

A hydrophobic substrate to which a liquid composition according to this invention can be applied is a substrate having a surface area where a water droplet has a contact angle of 60° or more, particularly 70° or more.

Surfaces where a water droplet has a contact angle of 60° or more, particularly 70° or more include a silicon substrate surface without an oxide film on its surface and a Low-K film.

The term “Low-K film” means a film having a low dielectric-constant of 4 or less. Examples include organic films such as an aromatic aryl polymer; siloxane films such as MSQ (Methyl Silsesquioxane) and HSQ (Hydrogen Silsesquioxane); SiOC films; and porous silica films, which have trade names of Black-diamond, SiLK, Lox, LKD, etc.

A liquid composition of this invention is preferably prepared such that the liquid composition or a dilute aqueous solution thereof has a contact angle of 50° or less on a surface where a water droplet has a contact angle of 60° or more, particularly it has a contact angle of 50° or less on a surface where a water droplet has a contact angle of 70° or more. In the light of particle removal, the composition or solution is prepared such that it preferably has a contact angle of 40° or less, more preferably 35° or less, particularly preferably 30° or less. In terms of a contact angle for a droplet of the liquid composition of this invention or a dilute aqueous solution thereof, it is preferable that the above conditions for a contact angle are met by an aqueous solution in which the total content of the phosphonic acid chelating agent and the polyoxyalkylene alkyl ether surfactant in the liquid composition is preferably 0.01 to 30 wt %, more preferably 0.01 to 10 wt %, further preferably 0.01 to 1 wt %. A composition meeting the conditions for a contact angle can improve wettability in a hydrophobic substrate surface during cleaning, resulting in efficient removal of particles and metallic contaminants.

The term “contact angle” as used herein means a contact angle determined by a droplet method (temperature: 25° C., droplet volume: 0.3 mL, time period between dropping and measurement: 5 sec.).

A phosphonic acid chelating agent in a liquid composition of this invention must have at least two phosphonic groups in one molecule in the light of effective removal of particles and metallic contaminants. Furthermore, in the light of availability and a cost for the compound, it preferably has two to five (both inclusive) phosphonic groups in one molecule. Examples of such a phosphonic acid chelating agent include 1-hydroxyethylidene-1,1-diphosphonic acid, ethylenediamine tetramethylenephosphonic acid, aminotrimethylenephosphonic acid, diethylenetriamine pentamethylenesulfonic acid, triethylenetetramine hexamethylenephosphonic acid and their salts. The salts are preferably ammonium salts, and primary to tertiary organic amine salts and quaternary organic ammonium salts may be also used. In an organic amine salt or organic ammonium salt, for example, one of organic groups attached to a nitrogen atom is independently lower alkyl group having 1 to 6 carbon atoms and lower hydroxyalkyl group having 1 to 6 carbon atoms. The phosphonic acid chelating agents may be used alone or in combination of two or more.

Among these phosphonic acid chelating agents, one or two or more selected from the group consisting of 1-hydroxyethylidene-1,1-diphosphonic acid, ethylenediamine tetramethylenephosphonic acid, aminotrimethylenephosphonic acid and their salts are preferable in the light of cleaning performance and solubility in water, and the salts are preferably ammonium salts.

A polyoxyalkylene alkyl ether surfactant in the liquid composition of this invention is selected such that a droplet of an aqueous solution containing the polyoxyalkylene alkyl ether surfactant preferably has a contact angle of 50° or less, more preferably 40° or less, further preferably 35° or less, particularly preferably 30° or less, on a surface where a water droplet has a contact angle of 60° or more or 70° or more. It is preferable that the above conditions for a contact angle are met by an aqueous solution in which the content of the polyoxyalkylene alkyl ether surfactant is preferably 0.001 to 30 wt %, more preferably 0.001 to 10 wt %, further preferably 0.01 to 1 wt %. A surfactant meeting the conditions for a contact angle can be added to adjust a contact angle of a liquid composition to a hydrophobic substrate within a desired range.

A polyoxyalkylene alkyl ether surfactant used in this invention can adjust a contact angle of a liquid composition to a hydrophobic substrate within a desired range, leading to improved wettability and further it can be combined with the above phosphonic acid compound to improve effectiveness in removal of particles. Furthermore, a liquid composition containing the surfactant is less foamable during cleaning or other handling processes. Such a surfactant is preferably a compound represented by general formula (1):

R—O—(CH₂CH₂O)ₙH (1)

wherein R represents alkyl group having 8 to 22 carbon atoms and n represents an integer of 1 to 30. In the light of particle removal effect and water solubility, n is preferably 2 to 20, more preferably 3 to 15. R may be straight or branched and preferably has 8 to 18 carbon atoms in the light of particle removal effect and water solubility.

A liquid composition of this invention may appropriately have a pH value according to an object to be cleaned. For more effectively removing metallic contaminants, the liquid may, for example, have an acidic pH of 2 to 6. On the other hand, for more effectively removing particles, it may, for example, have an alkaline pH of 8 to 13. A liquid composition of this invention exhibits excellent particle removing performance. Thus, when being acidic, the composition may exhibit excellent removing effect to metallic contaminants while maintaining adequate particle removing effect.

A content of the phosphonic acid chelating agent in the liquid composition of this invention is preferably 0.01 to 30 wt %, more preferably 0.01 to 10 wt %. A content of the polyoxyalkylene alkyl ether surfactant in the liquid composition is preferably 0.0001 to 10 wt %, more preferably 0.001 to 1 wt %. A ratio of the phosphonic acid chelating agent to the polyoxyalkylene alkyl ether surfactant (chelating agent/surfactant (by weight)) in the liquid composition of this invention may be appropriately adjusted within a range of, for example, 1/0.001 to 1/100. The total content of the phosphonic acid chelating agent and the polyoxyalkylene alkyl ether surfactant in the liquid composition of this invention is preferably 0.01 to 30 wt %, more preferably 0.01 to 10 wt %, further preferably 0.01 to 1 wt %. If a concentration or composition of liquid composition is significantly lower than the above range, desired cleaning effect cannot be achieved. If it is significantly higher than the range, storage stability may be deteriorated, for example, due to formation of an insoluble matter or a viscosity may be too high to properly handle the composition.

As long as desired properties are not deteriorated, a liquid composition of this invention may contain other agents including another chelating agent such as EDTA; another surfactant; a solubilizing agent such as inorganic phosphoric acid; a defoamer such as polyoxyalkylene alkyl ether; a preservative; and an oxidizer.

There are no particular restrictions to a cleaning process utilizing a liquid composition of this invention. For example, the composition may be effectively used in a single-wafer-processing type cleaning in which a cleaning liquid is fed to a substrate surface. More specifically, brush scrubbing may be employed, in which a substrate is cleaned by scrubbing with a brush while spraying a cleaning liquid on the substrate surface. In the brush scrubbing cleaning, a brush can be spun and shaken on a spinning substrate with a proper contact pressure to remove particles and metallic contaminants in combination with effects of the cleaning liquid.

In such a cleaning process, a liquid composition of this invention prepared as a stock solution with a relatively higher concentration may be diluted or adjusted to a given concentration, taking a cleaning method, cleaning conditions and an object to be cleaned into account before use. A temperature of the cleaning liquid during cleaning is preferably 10 to 80° C. in the light of cleaning performance, stability of ingredients in a cleaning liquid, damage on a substrate surface, an energy cost and operability. The temperature may be generally within a range from room temperature to an upper limit of easy temperature control, for example, 20 to 40° C.

A liquid composition of this invention may be applied to cleaning conducted in a variety of manufacturing processes and processing procedures using a hydrophobic substrate. For example, it can be used for cleaning conducted after different manufacturing steps for producing a semiconductor device. For example, the composition may be particularly effective for cleaning after CMP for leveling an interlayer insulating film formed using a Low-K film or after CMP for forming a damascene interconnection using a copper-containing metal as an interconnection material and a Low-K film as an inter-interconnection insulating film.

### EXAMPLES

There will be illustrated specific aspects of this invention.

Determination of a Contact Angle

A contact angle was determined by a droplet method using a contact angle measuring apparatus (Kyowa Interface Science Co. Ltd., Type CA-V) under the following conditions.

Droplet volume: 0.3 mL

Time between dropping and measurement: 5 sec

Temperature: 25° C.

Evaluation of Particle Removing Performance

An 8 inch silicon wafer on which a Low-K film was deposited was prepared. It was immersed in an aqueous slurry containing silica particles (average particle size=0.2 μm) for 60 sec to contaminate the wafer surface with silica particles. The contaminated wafer surface was cleaned by brush scrubbing while feeding a cleaning liquid at 25° C. for 1 min. Before and after the cleaning, particles remaining on the wafer surface were counted by a particle counter.

Evaluation of Removal Performance for Metallic Contaminants

On an 8 inch silicon wafer were sequentially deposited an SiOC film as a Low-K film, and a TaN film and a Cu film as metal films to prepare a substrate. The substrate was subject to CMP until the Low-K film was exposed. Thus, the Low-K film surface was contaminated with polishing particles and Cu polishing dusts. The contaminated wafer surface was cleaned by brush scrubbing while feeding a cleaning liquid at 25° C. for 1 min. The remaining Cu on the wafer surface was collected with an aqueous solution of hydrofluoric acid from the contaminated wafer before cleaning and after cleaning, and the amount of adhering Cu was determined by atomic absorption spectrometry.

### Examples and Comparative Examples

Aqueous solutions having the compositions shown in Table 1 were prepared. Then, the aqueous solutions were used as a cleaning liquid for cleaning and evaluation as described above. The results after cleaning are shown in Table 1.

TABLE 1

| | | | Particle | |
|---|---|---|---|---|
| | | | number | |
| | | | (count/ | Amount of |
| | Composition of | Contact | wafer | adhering Cu |
| | Cleaning Liquid | angle(°) | area) | (atoms/cm²) |
| Ex. 1 | Nonionic surfactant A: | 29 | 45 | 5 × 10⁹ |
| | 0.1 wt % Phosphonic acid | | | |
| | chelating agent: 0.1 wt % | | | |
| | pH 3 | | | |
| Ex. 2 | Nonionic surfactant B: | 26 | 95 | 5 × 10⁹ |
| | 0.1 wt % Phosphonic acid | | | |
| | chelating agent: 0.1 wt % | | | |
| | pH 3 | | | |
| Comp. | Oxalic acid: 0.1 wt % | 88 | >5000 | 3 × 10¹⁰ |
| Ex. 1 | | | | |
| Comp. | Pure water alone | - | >5000 | 8 × 10¹² |
| Ex. 2 | | | | |

Nonionic surfactant A: Polyoxyethylene lauryl ether (Ethylene oxide unit number n = 1 to 6).
Nonionic surfactant B: CH₃(CH₂)_{X}-CH(-(CH₂)_{Y}CH₃)-O-(CH₂CH₂O)ₙH (n = average 7, X + Y = 9 to 11).
Phosphonic acid chelating agent: 1-Hydroxyethylidene-1,1-diphosphonic acid.
Low-K film: SiOC film.

What is claimed is:

1. A liquid composition for cleaning a hydrophobic substrate which is used for cleaning a substrate having a surface area on which a water droplet exhibits a contact angle of 60° or more, comprising
a phosphonic acid chelating agent having at least two phosphonic groups in one molecule and a polyoxyalkylene alkyl ether type of nonionic surfactant,
wherein a droplet of the liquid composition or a dilute aqueous solution thereof exhibits a contact angle of 50° or less to the surface area.

2. The liquid composition for cleaning a hydrophobic substrate as claimed in claim 1 wherein the surface area is a low dielectric-constant film having a dielectric-constant of 4 or less.

3. The liquid composition for cleaning a hydrophobic substrate as claimed in claim 1 wherein a droplet of an aqueous solution prepared by dissolving the nonionic surfactant in water exhibits a contact angle of 50° or less to the surface area.

4. The liquid composition for cleaning a hydrophobic substrate as claimed in claim 1 wherein the nonionic surfactant is represented by general formula (1):
R—O—(CH₂CH₂O)ₙH (1)
wherein R represents alkyl group having 8 to 22 carbon atoms and n represents an integer of 1 to 30.

5. The liquid composition for cleaning a hydrophobic substrate as claimed in claim 1 wherein the phosphonic acid chelating agent is one or two or more selected from the group consisting of 1-hydroxyethylidene-1,1-diphosphonic acid, ethylenediamine tetramethylenephosphonic acid, aminotrimethylenephosphonic acid and their salts.

6. The liquid composition for cleaning a hydrophobic substrate as claimed in claim 1 wherein pH is within the range of 2 to 6.

7. A process for cleaning a substrate having a surface area where a water droplet exhibits a contact angle of 60° or more, comprising the steps of preparing the liquid composition as claimed in claim 1 and removing adherent materials on the substrate surface while feeding the liquid composition or a dilute aqueous solution thereof to the substrate surface.

8. The cleaning process as claimed in claim 7 wherein the substrate surface is scrubbed with a brush while feeding the liquid composition or a dilute aqueous solution thereof to the substrate surface.

9. The cleaning process as claimed in claim 7 wherein the adhesive materials to be removed are particles and metallic contaminants.
